(19) United States
(12) Patent Application Publication
(10) Pub. No.: US 2019/0346629 A1
(43) Pub. Date: Nov. 14, 2019

(54) OPTICAL CONNECTION COMPONENT AND OPTICAL COUPLING STRUCTURE

(71) Applicant: SUMITOMO ELECTRIC INDUSTRIES, LTD., Osaka-shi (JP)

(72) Inventor: Tetsu MORISHIMA, Yokohama-shi (JP)

(73) Assignee: SUMITOMO ELECTRIC INDUSTRIES, LTD., Osaka-shi (JP)

(21) Appl. No.: 16/519,187

(22) Filed: Jul. 23, 2019

Related U.S. Application Data
(63) Continuation of application No. PCT/JP2018/000196, filed on Jan. 9, 2018.

(30) Foreign Application Priority Data
Jan. 26, 2017 (JP) 2017-012212

(51) Int. Cl. G02B 6/38; G02B 6/26; G02B 6/122; G02B 6/42

(52) U.S. Cl. CPC G02B 6/3839; G02B 6/262; G02B 6/42; G02B 6/3854; G02B 6/122; G02B 6/3885

(57) ABSTRACT

An optical connection component includes a holding member that includes a front end surface, a rear end surface opposite to the front end surface, a reference surface, a pair of first guide holes provided on the front end surface, and a pair of second guide holes provided on the rear end surface; and an optical waveguide member that includes a front surface, a rear surface opposite to the front surface, a lower surface, and a plurality of optical waveguides extending from the front surface to the rear surface. Arrangement of first ends of the plurality of optical waveguides on the front surface and arrangement of second ends of the plurality of optical waveguides on the rear surface are different from each other. The optical waveguide member is held by the holding member such that the lower surface and the reference surface come into contact with each other.

### TECHNICAL FIELD

The present invention relates to an optical connection component and an optical coupling structure. The present application is based upon and claims the benefit of priority from Japanese Patent Application No. 2017-012212, filed on Jan. 26, 2017, the entire content of which is incorporated herein by reference.

### BACKGROUND ART

Non-Patent Literature 1 discloses a fan-out component subjected to physical contact (PC) connection with an LC connector-type multi core fiber (MCF). The fan-out component makes a fiber bundle in which seven single core fibers are bundled. In an MCF, one of seven cores is disposed along a central axis of the MCF, and the remaining six cores are disposed therearound at equal intervals. Seven single core fibers in the fiber bundle are provided to correspond to arrangement of the cores in the MCF. That is, in the fiber bundle, one of seven single core fibers is disposed along the central axis of the fiber bundle and the remaining six cores are disposed therearound at equal intervals.

### CITATION LIST

### Non-Patent Literature

Non-Patent Literature 1: Osamu Shimakawa and two others, “LC connector type multi-core fiber fan-out”, Communication Lecture Journal of IEICE Society Conference 2015, Institute of Electronics, Information and Communication Engineers, B-13-34, Aug. 25, 2015

### SUMMARY OF INVENTION

An optical connection component of the present disclosure relates to an optical connection component configured to be connected to a first optical waveguide component having a plurality of light incidence/emission portions and a second optical waveguide component having a plurality of light incidence/emission portions in a face-to-face manner in a first direction. The optical connection component comprises a holding member that includes a front end surface intersecting the first direction, a rear end surface opposite to the front end surface in the first direction, a reference surface intersecting a second direction orthogonal to the first direction, at least a pair of first guide holes provided on the front end surface, and at least a pair of second guide holes provided on the rear end surface; and an optical waveguide member that includes a front surface intersecting the first direction, a rear surface opposite to the front surface in the first direction, a lower surface intersecting the second direction, and a plurality of optical waveguides extending from the front surface to the rear surface. Arrangement of first ends of the plurality of optical waveguides on the front surface and arrangement of second ends of the plurality of optical waveguides on the rear surface are different from each other. The optical waveguide member is held by the holding member such that the lower surface and the reference surface come into contact with each other.

### BRIEF DESCRIPTION OF DRAWINGS

FIG. 1 is a perspective view of an optical connection component according to an embodiment.

FIG. 2 is a cross-sectional view of the optical connection component illustrated in FIG. 1 cut along line II-II.

FIG. 3 is a perspective view of an optical waveguide member.

FIG. 4 is a front view illustrating one end surface of the optical waveguide member.

FIG. 5 is a rear view illustrating an opposite end surface of the optical waveguide member.

FIG. 6 is a top view illustrating a constitution of optical coupling structures including the optical connection component according to the embodiment.

FIG. 7 is a perspective view of an optical waveguide member according to a modification example.

FIG. 8 is a rear view illustrating an opposite end surface of the optical waveguide member according to the modification example.

### DESCRIPTION OF EMBODIMENT

### Problem to be Solved by the Present Disclosure

The fan-out component disclosed in Non-Patent Literature 1 disposes cores of a fiber bundle around a central axis as well, and an MCF also has similar arrangement of the cores. To cause the positions of cores of the fiber bundle and the positions of cores of the MCF to coincide with each other, there is a need to perform rotation alignment work for the fiber bundle and the MCF. For example, the fiber bundle and the MCF are individually rotated around the central axis using a split sleeve, and the angles of the fiber bundle and the MCF around the central axis are set to predetermined angles. However, such a connection method requires the rotation alignment work for the fiber bundle in addition to the rotation alignment work for the MCF. Thus, steps required to connect the MCF with the fiber bundle increase, and the connection work takes time.

### Advantageous Effect of the Present Disclosure

According to an optical connection component and an optical coupling structure of the present disclosure, it is possible to simplify work of connecting optical waveguide components each having a plurality of light incidence/emission portions to each other.

### Description of Embodiment of Invention of this Application

Details of embodiments of the present application will be enumerated and described. An optical connection component according to one embodiment of the present application relates to an optical connection component configured to be connected to a first optical waveguide component having a plurality of light incidence/emission portions and a second optical waveguide component having a plurality of light incidence/emission portions in a face-to-face manner in a first direction. The optical connection component comprises a holding member that includes a front end surface intersecting the first direction, a rear end surface opposite to the front end surface in the first direction, a reference surface intersecting a second direction orthogonal to the first direction, at least a pair of first guide holes provided on the front end surface, and at least a pair of second guide holes provided on the rear end surface; and an optical waveguide member that includes a front surface intersecting the first direction, a rear surface opposite to the front surface in the first direction, a lower surface intersecting the second direction, and a plurality of optical waveguides extending from the front surface to the rear surface. Arrangement of first ends of the plurality of optical waveguides on the front surface and arrangement of second ends of the plurality of optical waveguides on the rear surface are different from each other. The optical waveguide member is held by the holding member such that the lower surface and the reference surface come into contact with each other.

In the optical connection component described above, when the lower surface of the optical waveguide member and the reference surface of the holding member come into contact with each other, a relative angle of the optical waveguide member with respect to the holding member around the first direction is restricted. In addition, when first guide pins are inserted into the first guide holes of the holding member, the relative angle of the first optical waveguide component with respect to the holding member around the first direction can be restricted, and when second guide pins are inserted into the second guide holes of the holding member, the relative angle of the second optical waveguide component with respect to the holding member around the first direction can be restricted. Therefore, it is possible to omit rotation alignment work to be performed when the first end of each of the optical waveguides and each of the light incidence/emission portions of the first optical waveguide component are optically coupled to each other, and rotation alignment work to be performed when the second end of each of the optical waveguides and each of the light incidence/emission portions of the second optical waveguide component are optically coupled to each other. That is, according to the optical connection component described above, it is possible to simplify work of connecting of the first optical waveguide component and the second optical waveguide component to each other.

In the optical connection component described above, the holding member may include a main body having a recessed inner wall surface recessed in the second direction. The reference surface may be a bottom surface of the recessed inner wall surface. The optical waveguide member may be accommodated inside a recess portion of the main body defined by the recessed inner wall surface. The holding member may have a lid covering the recess portion of the main body. The recessed inner wall surface of the holding member may further include a pair of inner wall surfaces facing each other in a third direction intersecting the first and second directions. The optical waveguide member may further include first and second side surfaces facing each other in the third direction. The first and second side surfaces and the lower surface of the optical waveguide member may respectively face and may come into contact with the pair of inner wall surfaces and the reference surface of the holding member. In these cases, it is possible to more reliably restrict the relative angle of the optical waveguide member with respect to the holding member around the first direction by more reliably realizing contact between the lower surface of the optical waveguide member and the reference surface of the holding member.

In the optical connection component described above, the front end surface and the front surface may be flush with each other. The rear end surface and the rear surface may be flush with each other. The holding member may further include a first step. The optical waveguide member may further include a second step facing the first step of the holding member in a part other than a part in which the plurality of optical waveguides are provided, between the front surface and the rear surface. The first step of the holding member and the second step of the optical waveguide member come into contact with each other and a position of the optical waveguide member with respect to the holding member in the first direction may be restricted. Since the front end surface of the holding member and the front surface of the optical waveguide member are flush with each other, the optical connection component and the first optical waveguide component can be connected to each other in a face-to-face manner. In addition, since the rear end surface of the holding member and the rear surface of the optical waveguide member are flush with each other, the optical connection component and the second optical waveguide component can be connected to each other in a face-to-face manner. In order for the front end surface and the front surface to be flush with each other and in order for the rear end surface and the rear surface to be flush with each other in this manner, the position of the optical waveguide member with respect to the holding member in the first direction needs to be accurately restricted. Thus, in the optical connection component described above, when the first step of the holding member and the second step of the optical waveguide member come into contact with each other, the position of the optical waveguide member with respect to the holding member in the first direction is restricted. Accordingly, it is possible to accurately set the position of the optical waveguide member with respect to the holding member in the first direction. The second step may be provided in a corner, adjacent to the lower surface, of the optical waveguide member.

In the optical connection component described above, a mode field diameter of the first end of each of the optical waveguides and a mode field diameter of the second end of each of the optical waveguides may be different from each other. Accordingly, even when the mode field diameters of the plurality of light incidence/emission portions of the first optical waveguide component and the mode field diameters of the plurality of light incidence/emission portions of the second optical waveguide component are different from each other, they can be efficiently connected to each other. The mode field diameter of the first end of each of the optical waveguides and the mode field diameter of the second end of each of the optical waveguides may be the same as each other.

In the optical connection component described above, in arrangement of the first ends of the plurality of optical waveguides, the first ends may be disposed at predetermined intervals in the third direction. In arrangement of the second ends of the plurality of optical waveguides, the second ends may be disposed in a rotationally symmetrical manner with respect to a predetermined axis.

In the optical connection component described above, the optical waveguide member including the plurality of optical waveguides may be formed of quartz glass. Accordingly, for example, it is possible to favorably realize the plurality of optical waveguides of the optical waveguide member using an ultra-short pulse laser such as a femtosecond laser.

In the optical connection component described above, the optical waveguide member including the plurality of optical waveguides may be formed of quartz glass including a refractive index adjustment material. Accordingly, for example, since the refractive index of each of the optical waveguides can be efficiently changed using an ultra-short pulse laser such as a femtosecond laser, it is possible to favorably realize the plurality of optical waveguides of the optical waveguide member.

According to another embodiment of the present invention, there is provided a first optical coupling structure including the optical connection component that has a constitution of any of those described above, a first optical waveguide component that includes a plurality of light incidence/emission portions corresponding to the first ends of the plurality of optical waveguides of the optical connection component and has a pair of guide holes, and the pair of first guide pins extending in the first direction. First ends of the pair of first guide pins in the first direction are respectively fitted into the pair of guide holes of the first optical waveguide component. The second ends of the pair of first guide pins are fitted into the pair of first guide holes of the optical connection component. The first optical coupling structure includes the optical connection component described above and the first optical waveguide component. Thus, it is possible to omit rotation alignment work to be performed when the first optical waveguide component and the optical connection component are connected to each other. Moreover, in this first optical coupling structure, the relative angle between the optical connection component and the first optical waveguide component around the first direction is determined by the pair of first guide pins. Accordingly, it is possible to accurately connect the optical connection component and the first optical waveguide component to each other. In the first optical coupling structure, the plurality of light incidence/emission portions of the first optical waveguide component may include core end surfaces of a plurality of single core fibers.

According to another embodiment of the present invention, there is provided a second optical coupling structure including the optical connection component that has a constitution of any of those described above, a second optical waveguide component that includes a plurality of light incidence/emission portions corresponding to the second ends of the plurality of optical waveguides of the optical connection component and has a pair of guide holes, and at least a pair of second guide pins extending in the first direction. The first ends of the pair of second guide pins in the first direction are fitted into the pair of guide holes of the second optical waveguide component. The second ends of the pair of second guide pins are fitted into the pair of second guide holes of the optical connection component. The second optical coupling structure includes the optical connection component described above and the second optical waveguide component. Thus, it is possible to omit rotation alignment work to be performed when the second optical waveguide component and the optical connection component are connected to each other. Moreover, in this second optical coupling structure, the relative angle between the optical connection component and the second optical waveguide component around the first direction is determined by the pair of second guide pins. Accordingly, it is possible to accurately connect the optical connection component and the second optical waveguide component to each other. The plurality of light incidence/emission portions of the second optical waveguide component may include core end surfaces of a multi core fiber having a plurality of cores and a cladding surrounding the cores.

### Detailed Embodiment of Invention of this Application

Specific examples of the optical connection component and the optical coupling structure according to the embodiment of the present invention will be described below with reference to the drawings. The present invention is not limited to these examples. The present invention is indicated by the claims and is intended to include all changes within meanings and a scope equivalent to the claims. In the following description, the same reference signs are applied to the same elements in description of the drawings, and duplicated description will be omitted.

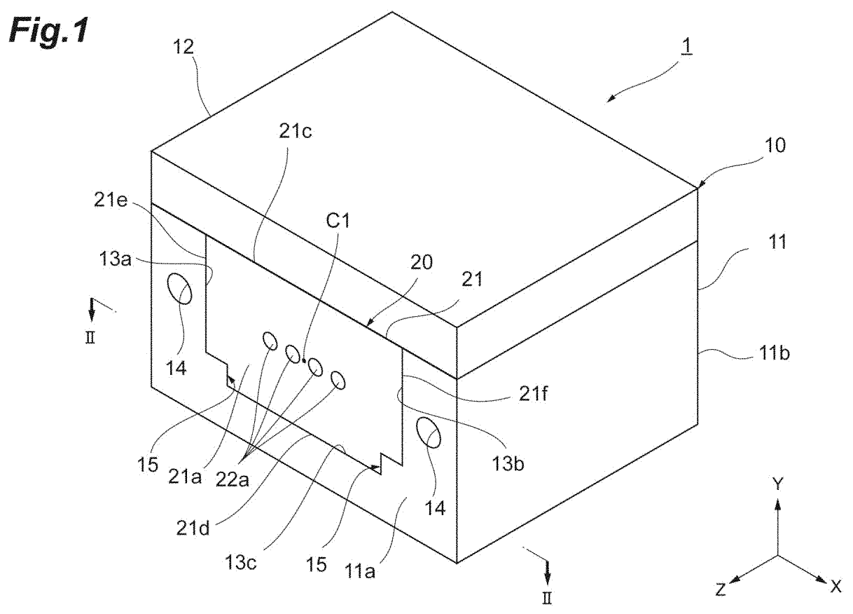

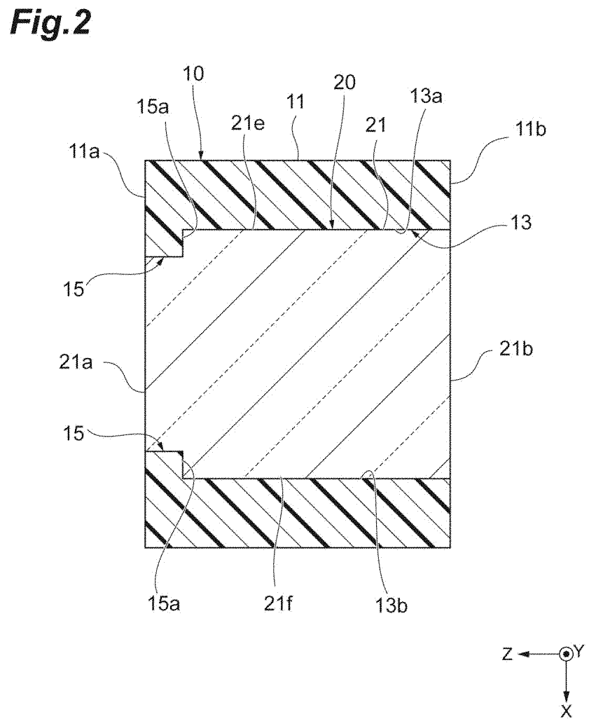

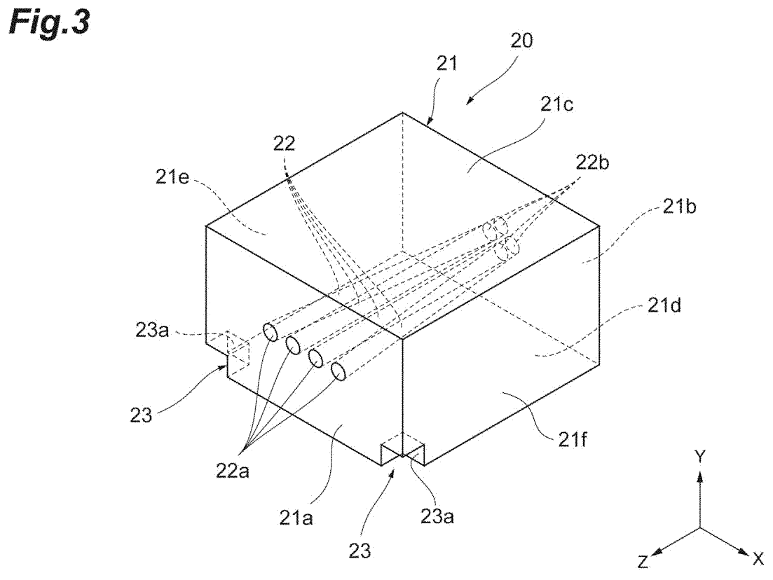

FIG. 1 is a perspective view of an optical connection component according to the present embodiment. FIG. 2 is a cross-sectional view of the optical connection component illustrated in FIG. 1 cut along line II-II. FIG. 3 is a perspective view of an optical waveguide member. In each of the diagrams, the XYZ orthogonal coordinate system is illustrated as necessary. As illustrated in FIGS. 1 and 2, an optical connection component 1 includes a holding member 10 and an optical waveguide member 20. The holding member 10 has a main body 11 and a lid 12. The main body 11 has a recessed cross section within an XY-plane and is open in a Y-direction. The lid 12 has a flat plate shape and is attached such that an open part (recess portion) of the main body 11 is covered. The lid 12 and the main body 11 are fixed to each other using an adhesive.

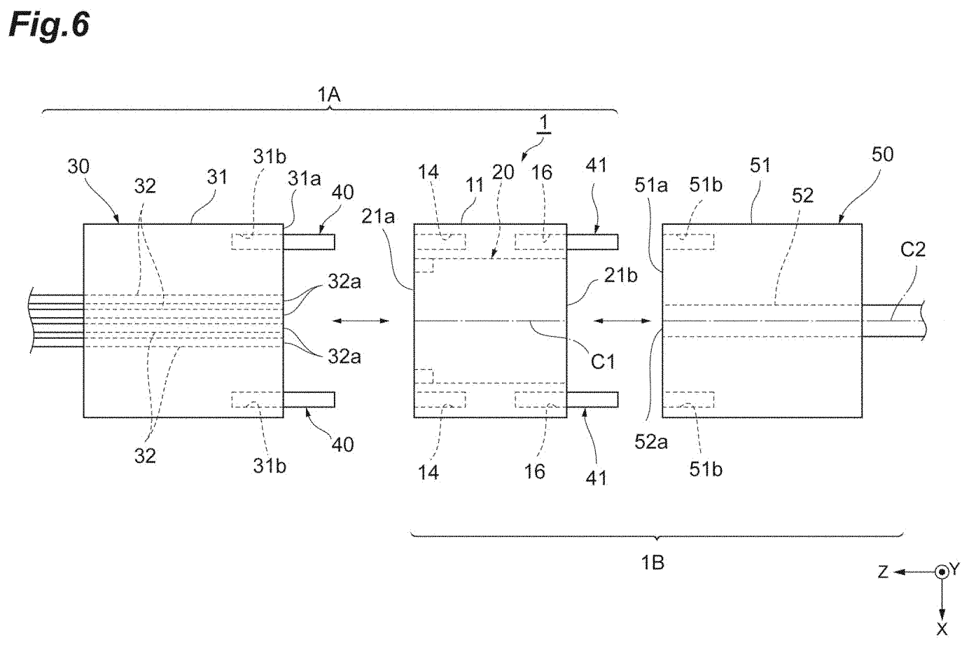

The main body 11 includes a front end surface 11a, a rear end surface 11b, a recessed inner wall surface 13, at least a pair of guide holes 14, and at least a pair of guide holes 16 which will be described below (refer to FIG. 6). The front end surface 11a is a flat surface and intersects (for example, is orthogonal to) a Z-direction. The rear end surface 11b is a flat surface, is provided opposite to the front end surface 11a, and intersects (for example, is orthogonal to) the Z-direction. As an example, the front end surface 11a and the rear end surface 11b are parallel to each other. The recessed inner wall surface 13 is the inner wall surface of an inner part of the main body 11 forming a recessed cross section and includes a plurality of surfaces. The recessed inner wall surface 13 is formed throughout an area from the front end surface 11a to the rear end surface 11b. The recessed inner wall surface 13 includes an inner wall surface 13a, an inner wall surface 13b, an inner wall surface 13c, and a pair of steps 15. The inner wall surface 13c may be the reference surface in the present embodiment. The inner wall surface 13a and the inner wall surface 13b are flat surfaces intersecting (for example, orthogonal to) an X-direction and facing each other. As an example, the inner wall surfaces 13a and 13b are parallel to each other, and the angles formed by the inner wall surfaces 13a and 13b and the front end surface 11a and the rear end surface 11b are 90°. The inner wall surface 13c intersects (for example, is orthogonal to) the Y-direction and connects the inner wall surface 13a and the inner wall surface 13b to each other. As an example, the angles formed by the inner wall surface 13c with respect to the front end surface 11a and the rear end surface 11b, and the inner wall surfaces 13a and 13b are 90°, respectively.

The pair of steps 15 are provided at both ends in the corners in the X-direction fainted by the front end surface 11a and the inner wall surface 13c. The pair of steps 15 protrude from the front end surface 11a toward the rear end surface 11b in the Z-direction and protrudes from the inner wall surface 13c toward the opening of the main body 11 in the Y-direction. One step 15 of the pair of steps 15 protrudes from the inner wall surface 13a toward the inner wall surface 13b in the X-direction, and the other step 15 protrudes from the inner wall surface 13b toward the inner wall surface 13a in the X-direction. Each of the pair of steps 15 has a flat stepped surface 15a intersecting (for example, orthogonal to) the Z-direction and being parallel to the front end surface 11a. The stepped surface 15a is provided nearer the rear end surface 11b in relation to the front end surface 11a in the Z-direction. That is, the stepped surface 15a is positioned between the front end surface 11a and the rear end surface 11b. These stepped surfaces 15a of the holding member 10 come into contact with stepped surfaces 23a of a pair of steps 23 (refer to FIG. 3) provided in the optical waveguide member 20 which will be described below. The pair of guide holes 14 have a circular cross section perpendicular to a central axis thereof. The pair of guide holes 14 is provided on the front end surface 11a. Specifically, the pair of guide holes 14 extend from the front end surface 11a in the Z-direction and is provided on both sides with the recessed inner wall surface 13 interposed therebetween in the X-direction. As an example, the pair of guide holes 14 can be formed on the front end surface 11a such that each of the central axes thereof is orthogonal to the front end surface 11a. A pair of guide pins 40 for restricting the angle of the holding member 10 with respect to an optical waveguide component 30 (refer to FIG. 6), which will be described below, around a central axis C1 (around the Z-direction) are inserted and fitted into the pair of guide holes 14.

The optical waveguide member 20 is held by the holding member 10. As illustrated in FIG. 3, the optical waveguide member 20 has a main body 21 and a plurality of optical waveguides 22. The main body 21 has substantially rectangular parallelepiped appearance. The plurality of optical waveguides 22 are provided inside the main body 21. Details of the plurality of optical waveguides 22 will be described below. The main body 21 and the plurality of optical waveguides 22 may be faulted of the same material. The main body 21 and the plurality of optical waveguides 22 are formed of quartz glass, for example. Alternatively, for example, the main body 21 and the plurality of optical waveguides 22 may be formed of quartz glass to which a refractive index adjustment additive (refractive index adjustment material) selected from the group consisting of fluorine (F), potassium (K), boron (B), aluminum (Al), germanium (Ge), and rubidium (Rb) is added. In this case, the additive may be added throughout the main body 21 and the plurality of optical waveguides 22 in their entirety or may be added to only a portion including the plurality of optical waveguides 22 of the main body 21.

As illustrated in FIG. 3, the main body 21 has a front surface 21a, a rear surface 21b, an upper surface 21c, a lower surface 21d, a first side surface 21e, a second side surface 21f, and the pair of steps 23. The front surface 21a is a flat surface intersecting (for example, orthogonal to) the Z-direction along an imaginary plane including the front end surface 11a. In one example, the front surface 21a and the front end surface 11a are flush with each other. The rear surface 21b is a flat surface being provided opposite to the front surface 21a and intersecting (for example, orthogonal to) the Z-direction along an imaginary plane including the rear end surface 11b. In one example, the rear surface 21b and the rear end surface 11b are flush with each other. In the present embodiment, the expression “being flush” is not limited to a case in which the positions of both surfaces completely coincide with each other, and it includes a case in which the positions of both surfaces have a difference to an extent of a manufacturing error. The upper surface 21c and the lower surface 21d intersect (for example, are orthogonal to) the Y-direction and are provided in a manner facing each other. The first side surface 21e and the second side surface 21f intersect (for example, are orthogonal to) the X-direction and are provided in a manner facing each other. Since the lower surface 21d, the first side surface 21e, and the second side surface 21f respectively face and come into contact with the inner wall surface 13c, the inner wall surface 13a, and the inner wall surface 13b, the main body 21 of the optical waveguide member 20 is held inside the recessed inner wall surface 13, and the angle of the optical waveguide member 20 with respect to the recessed inner wall surface 13 around the central axis C1 (around the Z-direction) is restricted. Then, since the upper surface 21c comes into contact with the lid 12, the optical waveguide member 20 is fixed to the holding member 10.

The pair of steps 23 are provided in a part other than a part in which the plurality of optical waveguides 22 of the main body 21 are provided. Specifically, the pair of steps 23 are provided at both ends in the corners in the X-direction formed by the front surface 21a and the lower surface 21d. The pair of steps 23 have shapes corresponding to the pair of steps 15 and are fitted to the pair of steps 15. The pair of steps 23 constitute depressions with respect to the front surface 21a in the Z-direction and constitute depressions with respect to the lower surface 21d in the Y-direction. One step 23 of the pair of steps 23 constitutes a depression with respect to the first side surface 21e in the X-direction, and the other step 23 constitutes a depression with respect to the second side surface 21f in the X-direction. Each of the pair of steps 23 has the flat stepped surface 23a intersecting (for example, orthogonal to) the Z-direction and being parallel to an imaginary plane including the front surface 21a. The stepped surface 23a is provided nearer the rear surface 21b in relation to the front surface 21a in the Z-direction. That is, the stepped surface 23a is positioned between the front surface 21a and the rear surface 21b. The stepped surface 23a faces the stepped surface 15a of the recessed inner wall surface 13 described above. When the stepped surface 23a of the optical waveguide member 20 and the stepped surface 15a of the holding member 10 come into contact with each other, the position of the optical waveguide member 20 with respect to the recessed inner wall surface 13 in the Z-direction is restricted.

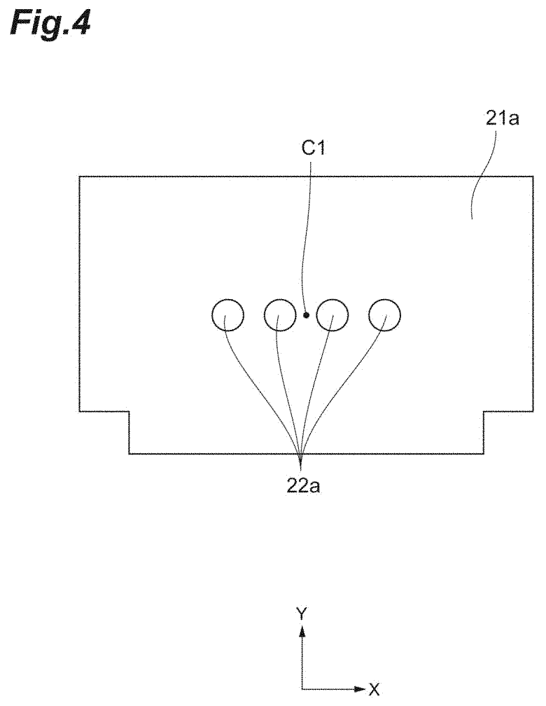

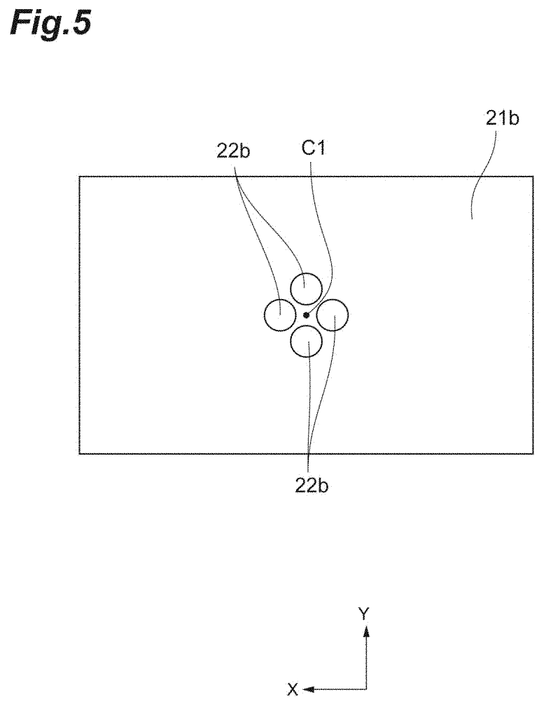

As illustrated in FIG. 3, the plurality of optical waveguides 22 extend from the front surface 21a to the rear surface 21b. One end surfaces 22a (one ends) of the plurality of optical waveguides 22 are included on the front surface 21a, and opposite end surfaces 22b (opposite ends) of the plurality of optical waveguides 22 are included on the rear surface 21b. In one example, the front surface 21a is perpendicular to an optical axis of each of the one end surfaces 22a, and the rear surface 21b is perpendicular to an optical axis of each of the opposite end surfaces 22b. Here, FIG. 4 is a front view illustrating the front surface 21a of the optical waveguide member 20. In one example, as illustrated in FIG. 4, four one end surfaces 22a are arranged in a row at equal intervals in the X-direction, and the shape of a mode field of each of the one end surfaces 22a is a circular shape. FIG. 5 is a rear view illustrating the rear surface 21b of the optical waveguide member 20. As illustrated in FIG. 5, arrangement of each of the opposite end surfaces 22b is different from arrangement of each of the one end surfaces 22a, and at least one of the opposite end surfaces 22b is disposed at a position excluding positions along the central axis C1 of the optical waveguide member 20. Each of the opposite end surfaces 22b is disposed in a rotationally symmetrical manner with respect to a predetermined axis (that is, the central axis C1). In one example, two opposite end surfaces 22b of four opposite end surfaces 22b are arranged in the X-direction, and two remaining opposite end surfaces 22b are arranged in the Y-direction such that the center between the two opposite end surfaces 22b are interposed therebetween. In one example, the shape of a mode field of each of the opposite end surfaces 22b is a circular shape, and the mode field diameter of each of the opposite end surfaces 22b coincides with the mode field diameter of each of the one end surfaces 22a. When the optical connection component 1 is manufactured, for example, the plurality of optical waveguides 22 are formed such that the one end surfaces 22a and the opposite end surfaces 22b of the plurality of optical waveguides 22 are disposed at predetermined positions based on the position of the lower surface 21d. Then, the optical waveguide member 20 is held by the recessed inner wall surface 13 such that the lower surface 21d, the first side surface 21e, and the second side surface 21f respectively face and come into contact with the inner wall surface 13c, the inner wall surface 13a, and the inner wall surface 13b.

The plurality of optical waveguides 22 having such a constitution is formed inside the main body 21 using a pulse laser, for example. A pulse laser is a titanium sapphire femtosecond laser (Ti-sapphire femtosecond laser), for example. Since the refractive index of the material of the main body 21 changes at a light focusing point of a light pulse output from a pulse laser, a plurality of three-dimensional optical waveguides 22 are formed inside the main body 21 such that the trajectory changes not only in the X-direction but also in the Y-direction by scanning this light focusing point. Here, when the main body 21 and the plurality of optical waveguides 22 are formed of quartz glass to which the additive described above is added, the condition of a change in the refractive index of the main body 21 at the light focusing point of the light pulse varies in accordance with the difference in additive. For example, when the additive is potassium, germanium, aluminum, or rubidium, the refractive index at the light focusing point of the light pulse becomes higher (larger) than the refractive index therearound. Thus, in this case, the plurality of optical waveguides 22 (core regions) are formed along the trajectory of the light focusing point of the light pulse. The change amount of the refractive index at the light focusing point of the light pulse varies in accordance with the difference in these additives. In contrast, for example, when the additive is fluorine or boron, the refractive index at the light focusing point of the light pulse becomes lower (smaller) than the refractive index therearound. Thus, in this case, a surrounding region (cladding region) of the plurality of optical waveguides 22 is formed along the trajectory of the light focusing point of the light pulse. The change amount of the refractive index at the light focusing point of the light pulse varies in accordance with the difference in these additives.

FIG. 6 is a top view illustrating a constitution of optical coupling structures 1A and 1B including the optical connection component 1 according to the present embodiment. The XZ coordinate system illustrated in FIG. 6 corresponds to the XYZ orthogonal coordinate system illustrated in FIGS. 1 to 5. As illustrated in FIG. 6, the optical coupling structure 1A includes the optical connection component 1, the optical waveguide component 30, and at least the pair of guide pins 40. The optical connection component 1 is connected to the optical waveguide component 30 in a face-to-face manner in the Z-direction. The optical waveguide component 30 includes a ferrule 31 and a plurality of single core fibers 32. For example, the ferrule 31 is an MT light connector ferrule. The ferrule 31 has a connection end surface 31a and at least a pair of guide holes 31b. The connection end surface 31a faces the front surface 21a and is subjected to physical contact (PC) connection with the front surface 21a in one example. The pair of guide holes 31b extend from the connection end surface 31a in the Z-direction and has a circular cross section perpendicular to the central axis thereof. The pair of guide holes 31b are provided at positions corresponding to the pair of guide holes 14. The inner diameters of the pair of guide holes 31b coincide with the inner diameters of the pair of guide holes 14. The plurality of single core fibers 32 are held by the ferrule 31. The plurality of single core fibers 32 extend from the connection end surface 31a in the Z-direction and are arranged in a row between the pair of guide holes 31b in the X-direction. Each of end surfaces 32a of the plurality of single core fibers 32 has a core exposed to the connection end surface 31a. The end surfaces of these cores serve as a plurality of light incidence/emission portions of the optical waveguide component 30. The cores respectively face the one end surfaces 22a and are optically coupled thereto. In one example, the shape of the mode field of each of the cores is a circular shape, and the mode field diameter of each of the cores and the mode field diameter of each of the one end surfaces 22a coincide with each other.

The pair of guide pins 40 extend in the Z-direction, and a cross section perpendicular to the central axis thereof has a circular shape. The outer diameters of the pair of guide pins 40 coincide with the inner diameters of the pair of guide holes 14 of the optical connection component 1 and the inner diameters of the pair of guide holes 31b of the optical waveguide component 30. One ends of the pair of guide pins 40 in the Z-direction are inserted and fitted into the pair of guide holes 31b, and the opposite ends of the pair of guide pins 40 are inserted and fitted into the pair of guide holes 14. The relative positions of each of the one end surfaces 22a of the optical connection component 1 and the plurality of single core fibers 32 of the optical waveguide component 30 within the XY-plane are set by the pair of guide pins 40, and the relative angle around the Z-direction is determined.

As illustrated in FIG. 6, the optical coupling structure 1B includes the optical connection component 1, an optical waveguide component 50, and at least a pair of guide pins 41. The optical connection component 1 is connected to the optical waveguide component 50 in a face-to-face manner in the Z-direction. In the pair of guide holes 16 of the optical connection component 1, a cross section perpendicular to the central axis thereof has a circular shape, and the pair of guide holes 16 extend from the rear end surface 11b in the Z-direction. As an example, the pair of guide holes 16 can be formed on the rear end surface 11b such that each of the central axes thereof is orthogonal to the rear end surface 11b. The pair of guide holes 16 are provided at positions similar to those of the pair of guide holes 14. That is, the pair of guide holes 16 are provided on both sides with the recessed inner wall surface 13 interposed therebetween in the X-direction. The optical waveguide component 50 includes a ferrule 51 and at least one multi core fiber (MCF) 52. The MCF 52 has a plurality of cores and a cladding surrounding the plurality of cores therein. For example, the ferrule 51 is an MT light connector ferrule. The ferrule 51 has a connection end surface 51a and a pair of guide holes 51b. The connection end surface 51a faces the rear surface 21b and is subjected to PC connection with the rear surface 21b in one example. The pair of guide holes 51b extend from the connection end surface 51a in the Z-direction and has a circular cross section perpendicular to the central axis thereof. The pair of guide holes 51b are provided at positions corresponding to the pair of guide holes 16. The inner diameters of the pair of guide holes 51b coincide with the inner diameters of the pair of guide holes 16.

The MCF 52 is held by the ferrule 51. In one example, as illustrated in FIG. 6, one MCF 52 is held by the ferrule 51. The MCF 52 extends from the connection end surface 51a in the Z-direction and is disposed between the pair of guide holes 51b in the X-direction. An end surface 52a of the MCF 52 has a plurality of cores exposed to the connection end surface 51a. The end surfaces of these cores serve as a plurality of light incidence/emission portions of the optical waveguide component 50. The plurality of cores are disposed in a rotationally symmetrical manner with respect to a predetermined axis (that is, a central axis C2). In one example, the shape of the mode field of each of the cores is a circular shape, and the mode field diameter of each of the cores and the mode field diameter of each of the opposite end surfaces 22b coincide with each other. The cores respectively face the opposite end surfaces 22b and are optically coupled thereto. When the optical waveguide component 50 is manufactured, the MCF 52 is rotationally aligned around the central axis C2 of the MCF 52 with respect to the ferrule 51. After the angle around the central axis C2 (around the Z-direction) of the MCF 52 is caused to coincide with a predetermined angle, the MCF 52 is fixed to the ferrule 51. As an example, the positions of the central axis C2 of the MCF 52 and the central axis C1 of the optical waveguide member 20 within the XY-plane coincide with each other.

The pair of guide pins 41 extend in the Z-direction, and a cross section perpendicular to the central axis thereof has a circular shape. The outer diameters of the guide pins 41 coincide with the inner diameters of the guide holes 16 and 51b. One ends of the pair of guide pins 41 in the Z-direction are inserted and fitted into the pair of guide holes 51b, and the opposite ends of the pair of guide pins 41 in the Z-direction are inserted and fitted into the pair of guide holes 16. In this manner, the relative positions of each of the opposite end surfaces 22b of the optical connection component 1 and the plurality of cores of the optical waveguide component 50 within the XY-plane are set by the pair of guide pins 41, and the relative angle around the Z-direction is determined.

In the optical coupling structures 1A and 1B according to the present embodiment, light emitted from the core of each of the single core fibers 32 is individually incident on each of the one end surfaces 22a, is individually emitted from each of the opposite end surfaces 22b, and is individually incident on each of the cores of the MCF 52. Alternatively, light emitted from each of the cores of the MCF 52 is individually incident on each of the opposite end surfaces 22b, is individually emitted from each of the one end surfaces 22a, and is individually incident on the core of each of the single core fibers 32.

The effects achieved by the optical connection component 1 and the optical coupling structures 1A and 1B according to the present embodiment described above will be described. In the present embodiment, when the lower surface 21d of the optical waveguide member 20 and the inner wall surface 13c of the recessed inner wall surface 13 come into contact with each other, the angle of the optical waveguide member 20 around the Z-direction is restricted. In addition, when the guide pins 40 are inserted into the guide holes 14 of the holding member 10, the relative angle of the optical waveguide component 30 with respect to the holding member 10 around the Z-direction is restricted, and when the guide pins 41 are inserted into the guide holes 16 of the holding member 10, the angle of the optical waveguide component 50 with respect to the holding member 10 around the Z-direction is restricted. Therefore, it is possible to omit rotation alignment work to be performed when the one end surface 22a of each of the optical waveguides 22 and the core of each of the single core fibers 32 are optically coupled to each other, and rotation alignment work to be performed when each of the opposite end surfaces 22b and each of the cores of the MCF 52 are optically coupled to each other. That is, according to the optical connection component 1 described above, it is possible to simplify work of connecting the optical waveguide component 30 and the optical waveguide component 50.

In the optical connection component 1, the front end surface 11a and the front surface 21a are flush with each other, and the rear end surface 11b and the rear surface 21b are flush with each other. The recessed inner wall surface 13 may further include the pair of steps 15. The optical waveguide member 20 may further have the pair of steps 23 facing the pair of steps 15 in a part other than a part in which the plurality of optical waveguides 22 are provided, between the front surface 21a and the rear surface 21b. As illustrated in FIG. 2, since the front end surface 11a and the front surface 21a are flush with each other and the rear end surface 11b and the rear surface 21b are flush with each other, the optical connection component 1 and the optical waveguide components 30 and 50 can be connected to each other in a face-to-face manner. Here, in order for the front end surface 11a and the front surface 21a to be flush with each other and in order for the rear end surface 11b and the rear surface 21b are flush with each other in this manner, the position of the optical waveguide member 20 with respect to the recessed inner wall surface 13 of the holding member 10 in the Z-direction needs to be accurately restricted. Thus, in the optical connection component 1 of the present embodiment, when the pair of steps 15 and 23 come into contact with each other, the position of the optical waveguide member 20 with respect to the recessed inner wall surface 13 of the holding member 10 in the Z-direction is restricted. Accordingly, it is possible to accurately set the position of the optical waveguide member 20 with respect to the holding member 10 in the Z-direction.

In the optical connection component 1, the plurality of optical waveguides 22 may be formed of quartz glass. Accordingly, it is possible to favorably realize the plurality of optical waveguides 22 of the optical waveguide member 20 using an ultra-short pulse laser such as a femtosecond laser.

In the optical connection component 1, the plurality of optical waveguides 22 may be formed of quartz glass to which a refractive index adjustment additive selected from the group consisting of fluorine, potassium, boron, aluminum, germanium, and rubidium is added. Accordingly, the refractive index of each of the optical waveguides 22 can be efficiently changed using an ultra-short pulse laser such as a femtosecond laser, and thus it is possible to favorably realize the plurality of optical waveguides 22 of the optical waveguide member 20.

The optical coupling structure 1A according to the present embodiment includes the optical connection component 1, the optical waveguide component 30, and the pair of guide pins 40 extending in the Z-direction. In the optical coupling structure 1A, the optical connection component 1 and the optical waveguide component 30 are connected to each other in a face-to-face manner via the pair of guide pins 40. In this optical coupling structure 1A, the relative angle between the optical connection component 1 and the optical waveguide component 30 around the Z-direction is determined by the pair of guide pins 40. Accordingly, it is possible to accurately connect the optical connection component 1 and the optical waveguide component 30 to each other.

The optical coupling structure 1B according to the present embodiment includes the optical connection component 1, the optical waveguide component 50, and the pair of guide pins 41 extending in the Z-direction. In the optical coupling structure 1B, the optical connection component 1 and the optical waveguide component 50 are connected to each other in a face-to-face manner via the pair of guide pins 41. In this optical coupling structure 1B, the relative angle between the optical connection component 1 and the optical waveguide component 50 around the Z-direction is determined by the pair of guide pins 41. Accordingly, it is possible to accurately connect the optical connection component 1 and the optical waveguide component 50 to each other.

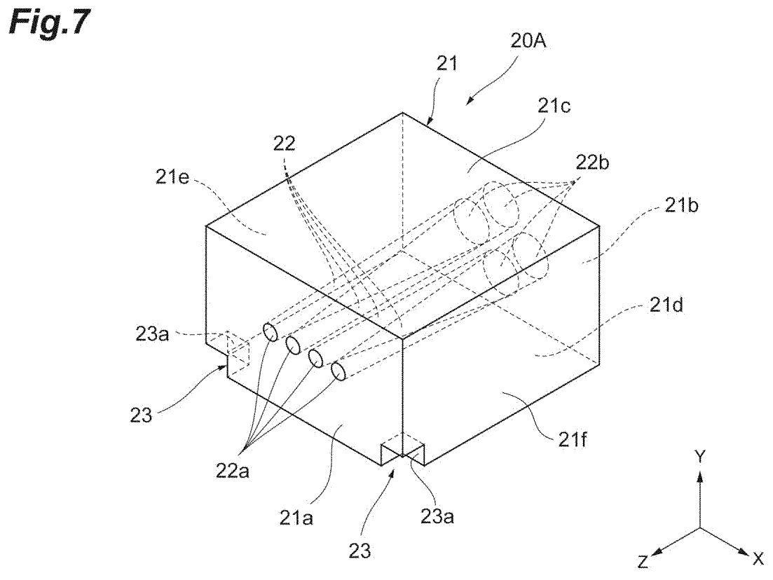

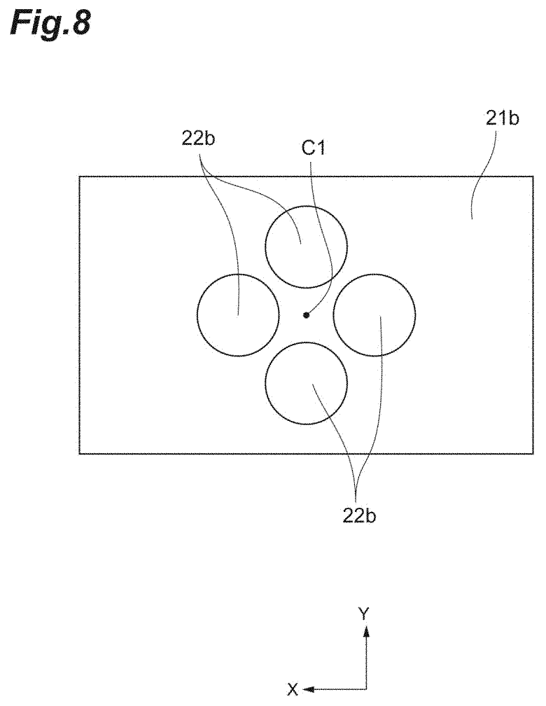

FIG. 7 is a perspective view of an optical waveguide member 20A according to a modification example. FIG. 8 is a rear view illustrating the rear surface 21b of the optical waveguide member 20A. The present modification example and the foregoing embodiment differ from each other in size of the mode field diameter of each of the opposite end surfaces 22b of the optical waveguide member 20 and each of the cores of the MCF 52 of the optical waveguide component 50. That is, the mode field diameter of the opposite end surface 22b of the plurality of optical waveguides 22 of the optical waveguide member 20A according to the present modification example is larger than the mode field diameter of the one end surface 22a of the plurality of optical waveguides 22 as illustrated in FIGS. 7 and 8. In other words, in the present modification example, the mode field diameter of the one end surface 22a of the optical waveguide 22 and the mode field diameter of the opposite end surface 22b of the optical waveguide 22 are different from each other. Accordingly, even when the mode field diameter of each of the single core fibers 32 and the mode field diameter of each of the cores of the MCF 52 are different from each other, each of the single core fibers 32 and each of the cores of the MCF 52 can be efficiently subjected to optical coupling.

The optical connection component and the optical coupling structure of the present invention are not limited to the embodiment described above, and various modifications can be made thereto. For example, the embodiment and the modification example described above may be combined together in accordance with the desired purpose and effect. In the embodiment described above, the opposite end surface 22b of each of the optical waveguides 22 is disposed in a rotationally symmetrical manner with respect to a predetermined axis (central axis C1). However, it may be disposed in a manner which is not rotationally symmetrical or may be further disposed along the central axis C1.

### REFERENCE SIGNS LIST

1 . . . Optical connection portion, 1A, 1B . . . Optical coupling structure, 10 . . . Holding member, 11, 21 . . . Main body, 11a . . . Front end surface, 11b . . . Rear end surface, 12 . . . Lid, 13 . . . Recessed inner wall surface, 13a, 13b, 13c . . . Inner wall surface, 14, 16, 31b, 51b . . . Guide hole, 15, 23 . . . Step, 15a, 23a . . . Stepped surface, 20, 20A Optical waveguide member, 21a . . . Front surface, 21b . . . Rear surface, 21c . . . Upper surface, 21d . . . Lower surface, 21e . . . First side surface, 21f . . . Second side surface, 22 . . . Optical waveguide, 22a . . . One end surface, 22b . . . Opposite end surface, 30, 50 . . . Optical waveguide component, 31, 51 . . . Ferrule, 31a, 51a . . . Connection end surface, 32 . . . Single core fiber, 40, 41 . . . Guide pin, 52 . . . MCF, C1, C2 . . . Central axis

1. An optical connection component configured to be connected to a first optical waveguide component having a plurality of light incidence/emission portions and a second optical waveguide component having a plurality of light incidence/emission portions in a face-to-face manner in a first direction, the optical connection component comprising:
a holding member that includes a front end surface intersecting the first direction, a rear end surface opposite to the front end surface in the first direction, a reference surface intersecting a second direction orthogonal to the first direction, at least a pair of first guide holes provided on the front end surface, and at least a pair of second guide holes provided on the rear end surface; and
an optical waveguide member that includes a front surface intersecting the first direction, a rear surface opposite to the front surface in the first direction, a lower surface intersecting the second direction, and a plurality of optical waveguides extending from the front surface to the rear surface,
wherein arrangement of first ends of the plurality of optical waveguides on the front surface and arrangement of second ends of the plurality of optical waveguides on the rear surface are different from each other, and
wherein the optical waveguide member is held by the holding member such that the lower surface and the reference surface come into contact with each other.

2. The optical connection component according to claim 1,
wherein the holding member includes a main body having a recessed inner wall surface recessed in the second direction, and the reference surface is a bottom surface of the recessed inner wall surface, and
wherein the optical waveguide member is accommodated inside a recess portion of the main body defined by the recessed inner wall surface.

3. The optical connection component according to claim 2, wherein the holding member includes a lid covering the recess portion of the main body.

4. The optical connection component according to claim 2,
wherein the recessed inner wall surface of the holding member further includes a pair of inner wall surfaces facing each other in a third direction intersecting the first and second directions,
wherein the optical waveguide member further includes first and second side surfaces facing each other in the third direction, and
wherein the first and second side surfaces and the lower surface of the optical waveguide member respectively face and come into contact with the pair of inner wall surfaces and the reference surface of the holding member.

5. The optical connection component according to claim 1, wherein the front end surface and the front surface are flush with each other, and the rear end surface and the rear surface are flush with each other.

6. The optical connection component according to claim 1,
wherein the holding member further includes a first step, and the optical waveguide member further includes a second step facing the first step of the holding member in a part other than a part in which the plurality of optical waveguides are provided, between the front surface and the rear surface, and
wherein the first step of the holding member and the second step of the optical waveguide member come into contact with each other and a position of the optical waveguide member with respect to the holding member in the first direction is restricted.

7. The optical connection component according to claim 6, wherein the second step is provided in a corner, adjacent to the lower surface, of the optical waveguide member.

8. The optical connection component according to claim 1, wherein a mode field diameter of the first end of each of the optical waveguides and a mode field diameter of the second end of each of the optical waveguides are different from each other.

9. The optical connection component according to claim 1,
wherein in the arrangement of the first ends of the plurality of optical waveguides, the first ends are disposed at predetermined intervals in the third direction, and
wherein in the arrangement of the second ends of the plurality of optical waveguides, the second ends are disposed in a rotationally symmetrical manner with respect to a predetermined axis.

10. The optical connection component according to claim 1, wherein the optical waveguide member is formed of quartz glass.

11. The optical connection component according to claim 1, wherein the optical waveguide member is formed of quartz glass including a refractive index adjustment material.

12. An optical coupling structure comprising:
the optical connection component according to claim 1;
a first optical waveguide component that includes a plurality of light incidence/emission portions corresponding to the first ends of the plurality of optical waveguides of the optical connection component and has a pair of guide holes; and
a pair of first guide pins extending in the first direction,
wherein first ends of the pair of first guide pins in the first direction are respectively fitted into the pair of guide holes of the first optical waveguide component, and second ends of the pair of first guide pins are fitted into the pair of first guide holes of the optical connection component.

13. The optical coupling structure according to claim 12, wherein the plurality of light incidence/emission portions of the first optical waveguide component include core end surfaces of a plurality of single core fibers.

14. An optical coupling structure comprising:
the optical connection component according to claim 1;
a second optical waveguide component that includes a plurality of light incidence/emission portions corresponding to the second ends of the plurality of optical waveguides of the optical connection component and has a pair of guide holes; and
a pair of second guide pins extending in the first direction,
wherein first ends of the pair of second guide pins in the first direction are fitted into the pair of guide holes of the second optical waveguide component, and second ends of the pair of second guide pins are fitted into the pair of second guide holes of the optical connection component.

15. The optical coupling structure according to claim 14, wherein the plurality of light incidence/emission portions of the second optical waveguide component include core end surfaces of a multi core fiber having a plurality of cores and a cladding surrounding the plurality of cores.
